(19) United States
(12) Patent Application Publication
(10) Pub. No.: US 2009/0230221 A1
(43) Pub. Date: Sep. 17, 2009

(54) Spray nozzle for liquid and device for spraying liquid comprising such a nozzle

(75) Inventor: Patrick Ballu, Reims (FR)

Correspondence Address: DOWELL & DOWELL P.C., 103 Oronoco St., Suite 220, Alexandria, VA, 22314, US

(73) Assignee: EXEL INDUSTRIES, Epemay (FR)

(21) Appl. No.: 12/382,368

(22) Filed: Mar. 13, 2009

(30) Foreign Application Priority Data
Mar. 14, 2008 (FR) 08 51673

(51) Int. Cl. B05B 1/02

(52) U.S. Cl. 239/597; 239/601; 239/602

(57) ABSTRACT

This spray nozzle (101) comprises:
a tubular channel (104) extending along a longitudinal axis (X₁₀₁-X′₁₀₁);
a slot (106) formed by two approximately plane surfaces (161), converging in the direction of the channel (104) and located on either side of a plane comprising the longitudinal axis (X₁₀₁-X′₁₀₁) of the channel (104); and
a dome (105) connecting the channel (104) and the slot (106).

The length (L₁₀₅) of the dome (105) represents less than 50%, preferably between 20% and 45%, of the largest transverse dimension (D₁₀₄) of the channel (104). A plane cross section of the dome (105) is symmetric and it is defined by at least two different circle arcs (C₁₀₅₁, C₁₀₅₂, C′₁₀₅₁, C′₁₀₅₂).

The present invention relates to a spray nozzle for liquid, in particular for coating liquid under high pressure. Furthermore, the invention relates to a device for spraying liquid, in particular for coating liquid under high pressure, comprising such a nozzle.

A device for spraying liquid or sprayer, either of the manual type or of the automatic type, generally comprises a spray nozzle, sometimes several, which is(are) mounted at the downstream end of the sprayer. The terms “upstream” and “downstream” herein refer to the direction of flow of the liquid in the sprayer. The term “upstream” denotes elements located on the side of the sprayer where the liquid to be sprayed arrives from a supply source. The term “downstream” denotes elements located on the side of the sprayer where the liquid is sprayed in droplets.

Such a sprayer may, for example, be intended for spraying coating liquids such as waterborne or solvent-based paints. To produce the spraying of the liquid in droplets, the sprayer is connected, by means of one of more tube(s), to a pump designed to put the liquid under high pressure, for example 70 bars. The spraying is carried out at the downstream end of the nozzle, which has a geometry determined depending on the desired shape for the jet of droplets of the sprayed liquid.

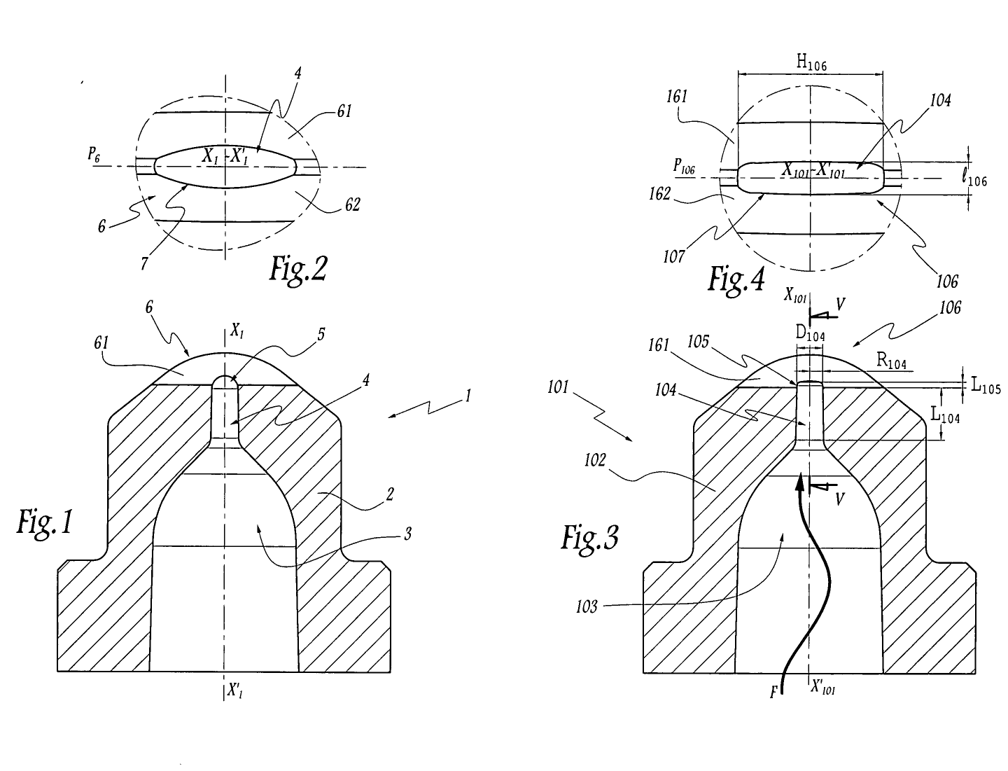

To the aim of shaping the jet of sprayed liquid into a “fan”, usually called a “flat” spray, a nozzle such as that illustrated by FIGS. 1 and 2 is known from the prior art. As FIG. 1 shows, the nozzle 1 comprises a body 2 which defines, on the upstream side, a chamber 3 through which the liquid arrives and, on the downstream side, a channel 4 for conveying the liquid from the chamber 3 through to the outlet of the nozzle 1. The chamber 3 and the channel 4 extend along a longitudinal axis X₁-X′₁ of the nozzle 1. Downstream of the channel 4, the nozzle 1 comprises a slot 6 intended to shape the liquid jet into a flat spray. As FIGS. 1 and 2 show, the slot 6 is formed by two surfaces 61 and 62 which are plane, which converge in the direction of the channel 4, and which are positioned on either side of a plane P₆ including axis X₁-X′₁. The one-eyed bottom of the channel 4 obtained in the body 2 before milling the slot 6 has the form of a hollow dome 5, which is herein referred to by the word “dome”. The dome 5 connects the channel 4 and the slot 6.

In nozzles of the prior art, the dome 5 has the shape of an ogive or triangular arch or a hemispherical shape, the length of which approximately equals the diameter of the channel 4. As FIG. 2 shows, the intersection of the dome 5 with the surfaces 61 and 62 of the slot 6 defines an outlet orifice 7 of the nozzle 1 in the overall shape of a flattened ellipse.

When the nozzle 1 sprays a liquid under high pressure, for example 70 bars, the geometry of the orifice 7 shapes the jet into a cone with an elliptical cross section. With the nozzle 1, the flow rate of the sprayed liquid is not uniformly distributed in this elliptical cross section. On the contrary, it has higher concentrations towards the distant edges of the ellipse. In the field of spraying coating liquids, this type of distribution of liquid is called the “tails effect”. It has been observed that the more rounded the edges of the ellipse are, the larger are the “tails” in the flow of liquid.

The “tails effect” has the drawback of leading to asymmetric wear of the nozzle 1, by overwearing down the edges of the orifice 7. The more abrasive the sprayed liquid is, the greater this wear is. This wear increases the “tails effect” and therefore leads to a reduction in the quality of the spraying. In addition, it reduces the service life of the nozzle 1, even when the material of the body 2 has a high hardness.

GB-A-1 312 052 describes a flat spray nozzle comprising a discontinuity at the junction between the channel and the dome connecting the channel and the slot of the nozzle. However, the nozzle of GB-A-1 312 052 does not permit to significantly decrease the “tails effect” so as to get a sufficient spraying quality.

The present invention aims in particular to solve these drawbacks by proposing a spray nozzle with a longer service life and enabling a flat jet to be produced with a relatively uniform distribution of liquid, and therefore to improve the spraying quality.

To this aim, the subject-matter of the invention is a spray nozzle for liquid, in particular for coating liquid under high pressure, comprising:
a tubular channel for channelling said liquid, said channel extending along a longitudinal axis;
a slot for shaping a jet of liquid coming from said channel, said slot being formed by two approximately plane surfaces, said surfaces converging in the direction of said channel and being positioned on either side of a plane comprising said longitudinal axis of said channel; and
a dome connecting said channel and said slot;
   The length of said dome, measured parallel to said longitudinal axis, represents less than 50%, preferably between 20% and 45%, of the largest transverse dimension of said channel, measured in a plane that is orthogonal to said longitudinal axis.

Said dome has a plane cross section that is symmetric relative to said longitudinal axis. Said plane cross section is defined by at least two circle arcs which extend between a downstream end portion of said channel and said longitudinal axis and which have different radii and centers located on the side of said channel.

According to other advantageous, but optional, features of the invention, taken in isolation or in any technically feasible combination:
said plane cross section is defined by three circle arcs which extend between said downstream end portion of said channel and said longitudinal axis and which have different radii and centers located on the side of said channel;
a first circle arc close to said downstream end portion of said channel has a radius less than half of the smallest dimension of said channel, measured in a plane orthogonal to said longitudinal axis, the circle arc the furthest from said downstream end portion of said channel having a radius greater than half the largest dimension of said channel, measured in a plane orthogonal to said longitudinal axis, and each other circle arc having a radius of a size greater than the radius of the preceding circle arc and less than the radius of the following circle arc;
said first circle arc is tangent to said downstream end portion of said channel and each other circle arc is tangent to the preceding circle arc;
said channel has a cylindrical form with a circular base, said dome has a rotational symmetry about said longitudinal axis of said channel;
the dimensions of said channel, measured in a plane that is orthogonal to said longitudinal axis, are between 0.1 mm and 1.8 mm;
said slot has a height of between 0.2 mm and 2 mm and a width of between 0.02 mm and 1.6 mm;
said surfaces form an angle of between 10° and 110° between them;
said nozzle is made of a material having a hardness greater than 50 on the Rockwell C scale, this material being able to be selected from the group comprising the tungsten carbides and the ceramics.

Furthermore, the subject-matter of the invention is a device for spraying liquid, in particular coating liquid under high pressure, characterized in that it comprises a nozzle such as disclosed above.

The invention will be well understood, and its advantages will become apparent, in the light of the following description, provided only by way of non limiting example and with reference to the annexed drawings, in which:

FIG. 1 is a cross section of a spray nozzle of the prior art;

FIG. 2 is a partial view from above, at a larger scale, of the spray nozzle illustrated in FIG. 1;

FIG. 3 is a cross section similar to that of FIG. 1 of a spray nozzle according to a first embodiment of the invention;

FIG. 4 is a view similar to that of FIG. 2 of the nozzle illustrated in FIG. 3;

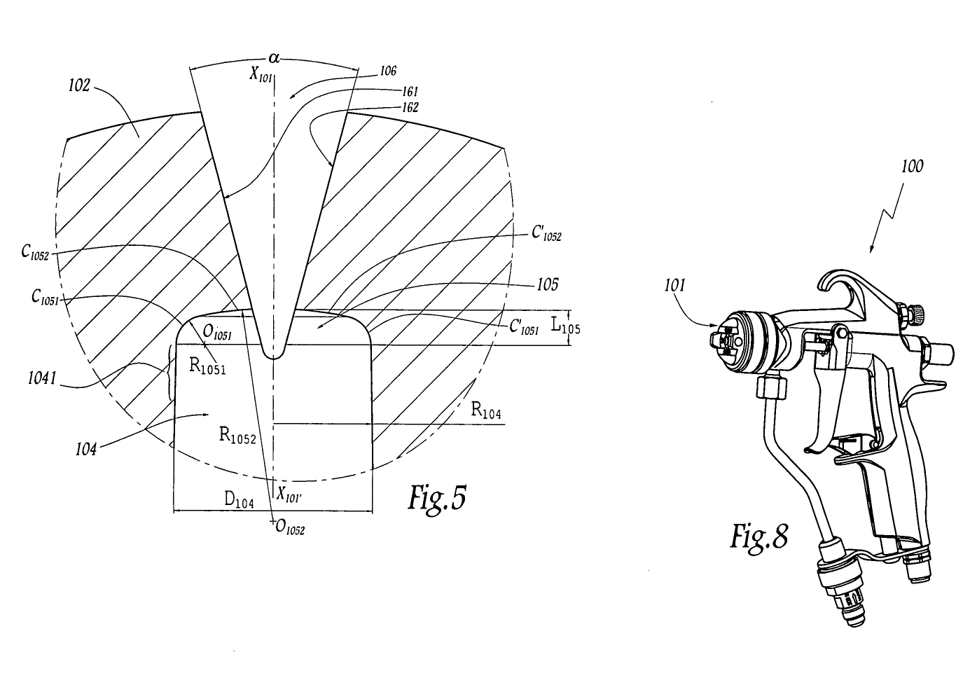

FIG. 5 is a partial cross section, at a larger scale, along the line V-V of FIG. 4;

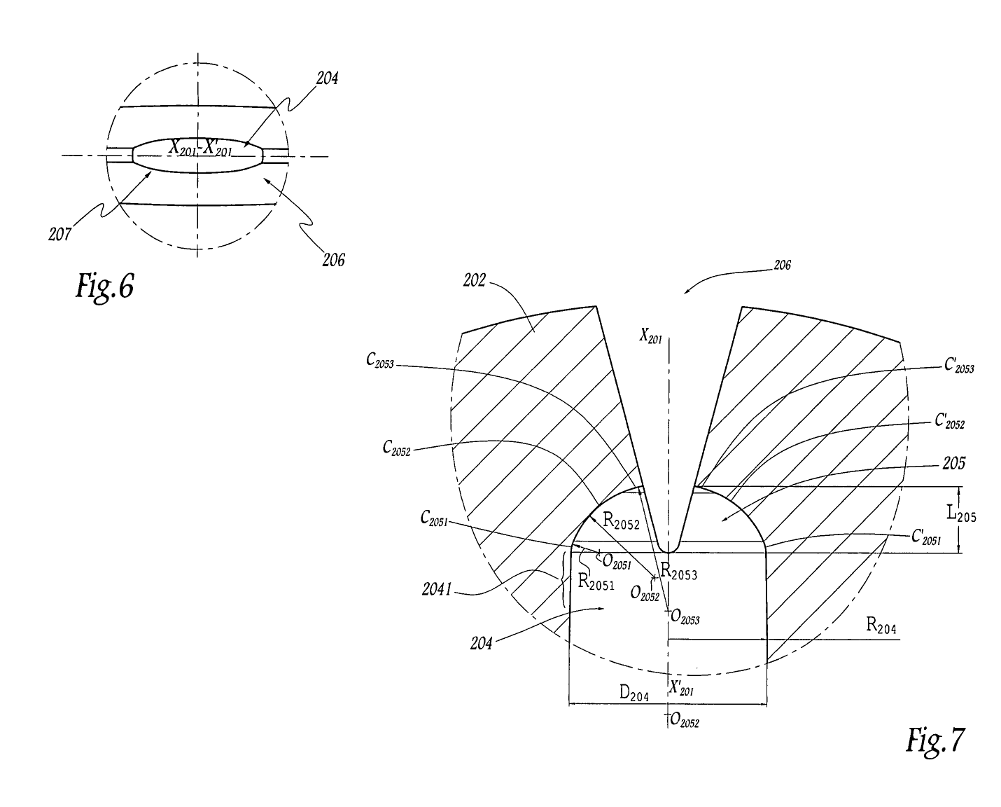

FIG. 6 is a view similar to that of FIG. 4 of a spray nozzle according to a second embodiment of the invention;

FIG. 7 is a view similar to that of FIG. 5 of the nozzle partially illustrated in FIG. 6; and

FIG. 8 is a perspective view of a spraying device according to the invention comprising a nozzle according to the invention.

As FIG. 3 shows, the nozzle 101 comprises a body 102 which defines, on the upstream side, a chamber 103 through which the liquid arrives and, on the downstream side, a channel 104 for conveying the liquid from the chamber 103 through to the outlet of the nozzle 101. The direction of flow of the fluid through the nozzle 101 is represented by an arrow F, which then allows to notice the upstream and downstream sides of the nozzle 101.

The chamber 103 and the channel 104 extend along a longitudinal axis X₁₀₁-X′₁₀₁ of the nozzle 101. In the example of FIG. 3, the channel 104 has the overall form of a cylinder with an axis X₁₀₁-X′₁₀₁ and a circular base of diameter D₁₀₄. Downstream of the channel 104, the nozzle 101 comprises a slot 106 intended to shape the liquid jet into a flat spray. As FIGS. 3 and 4 show, the slot 106 is formed by two surfaces 161 and 162 which are plane, which converge in the direction of the channel 104, and which are positioned on either side of a plane P₁₀₆ comprising the axis X₁₀₁-X′₁₀₁.

The nozzle 101 furthermore comprises a dome 105 connecting the channel 104 and the slot 106. “Dome” denotes the one-eyed base of the channel 104, which is obtained in the body 102 before milling the slot 106. “Connecting” means bringing into fluid communication.

The length L₁₀₅ of the dome 105, measured parallel to the longitudinal axis X₁₀₁-X′₁₀₁, here represents 25% of the diameter D₁₀₄ of the channel 104. In practice, the length L₁₀₅ of the dome 105 represents less than 50%, preferably between 20% and 45%, of the diameter D₁₀₄ of the channel 104. In other words, the dome 105 has a short or flattened shape in relation to the dome 5 of the nozzle 1 of the prior art illustrated in FIG. 1.

The tubular channel of the nozzle subject-matter of the invention may, as a variant, be prismatic in shape or be in a cylindrical shape with a non-circular base, for example an elliptical base. In this case too, the length of the dome is less than 50%, preferably between 20% and 45%, of the largest transverse dimension of the channel, measured in a plane orthogonal to the longitudinal axis of the nozzle.

The dome 105 has rotational symmetry around the axis X₁₀₁-X′₁₀₁. A cross section of the dome 105 through a plane containing the axis X₁₀₁-X′₁₀₁, for example through the plane P₁₀₆, is defined by two circle arcs C₁₀₅₁ and C₁₀₅₂ that extend between a downstream end portion 1041 of the channel 104 and the axis X₁₀₁-X′₁₀₁. The circle arcs C₁₀₅₁ and C₁₀₅₂ have the respective radii R₁₀₅₁ and R₁₀₅₂ and respective centres O₁₀₅₁ and O₁₀₅₂ located on the side of the channel 104, i.e. opposite the downstream portion of slot 106.

On the right-hand part of FIG. 5, the two arcs C′₁₀₅₁ and C′₁₀₅₂ extend between the end portion 1041 of the channel 104 and the axis X₁₀₁-X′₁₀₁, symmetrically with the arcs C₁₀₅₁ and C₁₀₅₂ relative to the axis X₁₀₁-X′₁₀₁. The radius R₁₀₅₁ is relatively small compared with the radius R₁₀₅₂. Thus, the radius R₁₀₅₁ is less than half the diameter D₁₀₄, which represents both the smallest and the largest transverse dimension of the channel 104. “Transverse” denotes a dimension measured in a plane orthogonal to the longitudinal axis X₁₀₁-X′₁₀₁. Conversely, the radius R₁₀₅₂ is greater than half the diameter D₁₀₄ of the channel 104.

In addition, the circle arc C₁₀₅₁ is tangent to the end portion 1041 of the channel 104 and the circle arc C₁₀₅₂ is tangent to the circle arc C₁₀₅₁. Thus the arcs C₁₀₅₁ and C₁₀₅₂ are joined in a continuous manner and without any singularity. By symmetry, the geometry of the arcs C′₁₀₅₁ and C′₁₀₅₂ is identical to that of the arcs C₁₀₅₁ and C₁₀₅₂. The dome 105 thus has a shape that is overall trapezoidal or a shape of half a convex lens.

The shape of the dome 105 may be comprised of more than two circle arcs joined to each other. In such a case, the radius of the circle arc closest to the downstream end portion of the channel is less than half the largest transverse dimension of the channel, the radius of the circle arc furthest from the downstream end portion of the channel is greater than half the largest transverse dimension of the channel; and each other circle arc has a radius of a size greater than the radius of the preceding circle arc and less than the radius of the following circle arc. In addition, in such a case, each circle arc is tangent to the preceding circle arc.

In the example of FIGS. 3 to 5, the slot 106 has a height H₁₀₆ of around 0.55 mm and a width l₁₀₆ of around 0.12 mm. The height H₁₀₆ is considered in the direction defined by the intersection of the plane P₁₀₆ with the plane of FIG. 4 and the width l₁₀₆ is measured in the plane of FIG. 4 and perpendicular to the plane P₁₀₆. In practice, the height H₁₀₆ may be between 0.2 mm and 2 mm and the width l₁₀₆ may be between 0.02 mm and 1.6 mm. As FIG. 5 shows, the surfaces 161 and 162 form an angle α of around 30° between them. In practice, the angle α may be between 10° and 110°.

The channel 104 has a length L₁₀₄, measured along the axis X₁₀₁-X′₁₀₁, of around 1.1 mm. In practice, the length L₁₀₄ may be between 0.4 mm and 3.5 mm. Moreover, the diameter D₁₀₄ of the channel 104 has a value of around 0.55 mm and may in practice be between 0.1 mm and 1.8 mm.

As FIG. 4 shows, the intersection of the “flattened” or “short” dome 105 with the plane surfaces 161 and 162 that form the slot 106 defines an outlet orifice 107 that is approximately rectangular in shape with rounded corners. To the extent that the surfaces 161 and 162 are symmetric in relation to the plane P₁₀₆ and the dome 105 has a symmetry with the axis X₁₀₁-X′₁₀₁, the orifice 107 has, in the elevation of FIG. 4, a symmetry by quadrants, the center of which is at the intersection of the plane P₁₀₆, of the axis X₁₀₁-X′₁₀₁ and of the plane of FIG. 4.

The geometry and the dimensions of the nozzle 101, in particular of its flattened dome 105, define the approximately rectangular shape of the outlet orifice 107. Such a nozzle enables to considerably reduce the “tails effect”, hence to render the liquid flow rate more uniform in the jet sprayed under, for example, 70 bars, or even under lower pressure, for example 40 bars. To the extent that this sprayed jet is more uniform, the quality of the spraying, hence of the application of this jet for example the coating of an object, is significantly improved. In addition, as the “tails effect” is reduced, the wearing of the edges of the outlet orifice 107 of a nozzle 101 according to the invention is greatly reduced, thereby increasing the service life of the nozzle 101.

The description of FIGS. 4 and 5 given above can be directly transposed to FIGS. 6 and 7, except the hereafter stated differences. An element of FIG. 6 or 7 similar or corresponding to an element of FIG. 4 or 5 gets the same numerical reference with prefix 2 replacing prefix 1.

One thus defines a nozzle 201, a longitudinal axis X₂₀₁-X′₂₀₁, a body 202, a channel 204 with a diameter D₂₀₄ and a radius R₂₀₄, a dome 205 with a length L₂₀₅, a slot 206 with an outlet orifice 207, circle arcs C₂₀₅₁ and C₂₀₅₂ with respective radii R₂₀₅₁ and R₂₀₅₂ and respective centers O₂₀₅₁ and O₂₀₅₂ and a downstream end portion 2041.

The nozzle 201 differs from the nozzle 101, because the plane cross section of the dome 205 is defined by three circle arcs C₂₀₅₁, C₂₀₅₂ and C₂₀₅₃, instead of two for the dome 105. Alike the plane cross section of FIG. 5, the plane cross section of FIG. 7 is symmetric with respect to longitudinal axis X₂₀₁-X′₂₀₁. Thus, on the right-hand part of FIG. 7, three arcs C′₂₀₅₁, C′₂₀₅₂ and C′₂₀₅₃ extend between the end portion 2041 of the channel 204 and axis X₂₀₁-X′₂₀₁, symmetrically with the arcs C₂₀₅₁, C₂₀₅₂ and C₂₀₅₃ relative to the axis X₂₀₁-X′₂₀₁.

The radius R₂₀₅₃ is greater than the radius R₂₀₅₂, the latter being itself greater than the radius R₂₀₅₁. Furthermore, the radius R₂₀₅₁ is less than the radius R₂₀₄ of the channel 204 and the radius R₂₀₅₃ is greater than the radius R₂₀₄.

The geometry and the dimensions of the nozzle 201, in particular of its dome 205, permit to further decrease the “tails effect”, hence to render more uniform the liquid flow rate in the sprayed jet, with respect to nozzle 101.

FIG. 8 illustrates a sprayer 100 or device for spraying liquid, in particular coating liquid under high pressure, comprising a nozzle 101 according to the invention. The sprayer 100 therefore produces sprays of improved quality and relatively uniform. In addition, the sprayer 100 requires fewer operations for replacing the nozzle 101.

To the aim of further increasing the service life of the nozzle 101, the latter may be made of a material having a high hardness, which may be selected from the group comprising the tungsten carbides and the ceramics or any other material having a high hardness. A high hardness means a hardness greater than 50 on the Rockwell C scale.

1. Spray nozzle for liquid, in particular for coating liquid under high pressure, comprising:
a tubular channel for channelling said liquid, said channel extending along a longitudinal axis;
a slot for shaping a jet of liquid coming from said channel, said slot being formed by two approximately plane surfaces, said surfaces converging in the direction of said channel and being located on either side of a plane comprising said longitudinal axis of said channel; and
a dome connecting said channel and said slot;
the length of said dome, measured parallel to said longitudinal axis, representing less than 50%, preferably between 20% and 45%, of the largest transverse dimension of said channel, measured in a plane that is orthogonal to said longitudinal axis,
said nozzle being characterized in that said dome has a plane cross section that is symmetric relative to said longitudinal axis, said plane cross section being defined by at least two circle arcs which extend between a downstream end portion of said channel and said longitudinal axis and which have different radii and centers located on the side of said channel.

2. The spray nozzle of claim 1, characterized in that said plane cross section is defined by three circle arcs which extend between said downstream end portion of said channel and said longitudinal axis and which have different radii and centers located on the side of said channel.

3. The spray nozzle of claim 1, characterized in that a first circle arc close to said downstream end portion of said channel has a radius less than half of the smallest dimension of said channel, measured in a plane orthogonal to said longitudinal axis, and in that the circle arc the furthest from said downstream end portion of said channel has a radius greater than half the largest dimension of said channel, measured in a plane orthogonal to said longitudinal axis, and in that each other circle arc has a radius of a size greater than the radius of the preceding circle arc and less than the radius of the following circle arc

4. The spray nozzle of claim 3, characterized in that said first circle arc is tangent to said downstream end portion of said channel and in that each other circle arc is tangent to the preceding circle arc.

5. The spray nozzle of claim 1, characterized in that said channel has a cylindrical form with a circular base and in that said dome has a rotational symmetry about said longitudinal axis of said channel.

6. The spray nozzle of claim 1, characterized in that the dimensions of said channel, measured in a plane that is orthogonal to said longitudinal axis, are between 0.1 mm and 1.8 mm.

7. The spray nozzle of claim 1, characterized in that said slot has a height of between 0.2 mm and 2 mm and a width of between 0.02 mm and 1.60 mm.

8. The spray nozzle of claim 1, characterized in that said surfaces form an angle of between 10° and 110° between them.

9. The spray nozzle of claim 1, characterized in that it is made of a material having a hardness greater than 50 on the Rockwell C scale, this material being able to be selected from the group comprising the tungsten carbides and ceramics.

10. A device for spraying liquid, in particular coating liquid under high pressure, characterized in that it comprises a spray nozzle according to claim 1.
